(19) United States
(12) Patent Application Publication
(10) Pub. No.: US 2024/0167514 A1
(43) Pub. Date: May 23, 2024

(54) BEARING CAGE AND BEARING

(71) Applicant: AKTIEBOLAGET SKF, GOTEBORG (SE)

(72) Inventors: Jinyan LU, Yinchuan (CN); Ya WANG, Shanghai (CN); Yawei SHAO, Shanghai (CN)

(21) Appl. No.: 18/510,156

(22) Filed: Nov. 15, 2023

(30) Foreign Application Priority Data
Nov. 23, 2022 (CN) 202211478453.6

(51) Int. Cl. F16C 33/54

(52) U.S. Cl. CPC F16C 33/548

(57) ABSTRACT

A bearing cage for holding rollers between an outer ring and an inner ring of a bearing includes a first side ring, a second side ring axially spaced from the first side ring and a plurality of circumferentially spaced bridges connecting the first side ring and the second side ring. The first side ring includes at least one radially inward extending circumferential projection, and the at least one projection may be a plurality of projections separated by a plurality of gaps.

### CROSS-REFERENCE

This application claims priority to Chinese patent application no. 202211478453.6 filed on Nov. 23, 2022, the contents of which are fully incorporated herein by reference.

### Technological Field

The present disclosure relates to the field of mechanical equipment, in particular to a bearing cage and a bearing including the bearing cage.

### BACKGROUND

Bearings are used to support mechanical rotating bodies in mechanical equipment. A bearing changes the sliding friction between a rotation shaft and a shaft seat into rolling friction and thus reduces friction loss.

The bearing generally includes an inner ring, an outer ring, rollers and a cage. The rollers may be spherical, cylindrical or conical, and the inner ring and the outer ring may also have various shapes so as to meet different requirements based on the expected load and size. The cage is used to retain the rollers between the inner ring and the outer ring and to separate adjacent rollers.

During use, the bearings are usually lubricated by lubricating oil or grease. In a case where lubricating oil is adopted for lubrication, the flow direction of the oil path may be designed according to the operation condition of the equipment so that the lubricating oil enters from a side of the bearing and flows through the interior of the bearing, thereby reducing the friction between the rollers and other components.

However, there is still a need for an improved bearing structure to improve the lubrication.

### SUMMARY

In view of the above problem, according to a first aspect of the present disclosure, a bearing cage is provided for holding rollers between an outer ring and an inner ring of a bearing, and the bearing cage includes a first side ring, a second side ring axially spaced apart from the first side ring, and a plurality of bridges (bridges) arranged at intervals and connecting the first side ring and the second side ring. The first side ring is provided with at least one circumferential projection that extends radially inward from the first side ring.

The bearing cage according to the present disclosure can solve the following technical problem: in a case where the rotational speed of a bearing is low, such as when the equipment is started, the temperature of the bearing rises rapidly due to insufficient lubrication, and in a case where the rotational speed of the bearing is high, such as when the equipment is in normal operation, the amount of lubricating oil entering the bearing becomes excessive, resulting in excessive stirring resistance. The principle of the present disclosure is described in detail as follows.

The bearing cage of the present disclosure can be used with various lubrication approaches that provide lubricating oil to the bearing from an axial side of the bearing, especially in situations where the lubricating oil splashes into the bearing from an axial side of the bearing. In these lubrication approaches, a portion of the lubricating oil that is sprayed or otherwise moved toward a side of the bearing can axially pass through the space between the circumferential projections, that is, the gaps located circumferentially between adjacent ones of the circumferential projections and reach the rollers, while another portion is blocked by the moving circumferential projections, thus falling or flowing onto the rotation shaft. That is, this another portion of the lubricating oil is “cut off” by the circumferential projections.

Moreover, the bearing cage of the present disclosure allows different proportions of the lubricating oil to pass through the circumferential gaps and further reach the rollers at different rotational speeds. Under the condition that the rotational speed of the bearing is slow, enough lubricating oil can pass through the gaps and reach the rollers, thus lubricating the rollers, the inner ring and the outer ring and taking away a certain amount of heat. Therefore, a temperature rise of the bearing due to insufficient lubrication can be better alleviated. Under the condition that the rotational speed of the bearing is fast, even if the amount of lubricating oil sprayed toward a side of the bearing remains unchanged, less lubricating oil can reach the rollers because the circumferential projections move fast along the circumferential direction, and it will be easier for their surfaces to “cut off” the moving lubricating oil. This can reduce the stirring resistance caused by lubricating oil inside the bearing when the rotational speed of the equipment is high, thus reducing the energy consumption of the equipment.

The present disclosure will be particularly beneficial for tapered roller bearings. This is because a tapered roller bearing, when running, produces a pumping effect that “sucks” the lubricating oil from the first side ring to the second side ring. When the bearing is rotating at a high speed, the pumping effect leads to more lubricating oil between the rollers and other components, which then leads to greater stirring resistance. On the other hand, the bearing cage of the present disclosure significantly reduces the amount of lubricating oil reaching the rollers when the bearing is rotating at a high speed, thus significantly reducing the stirring resistance.

Therefore, with the bearing cage of the present disclosure, different amounts of lubricating oil can reach the rollers at different rotational speeds of the bearing so that improved lubrication effect at both low speed and high speed is obtained.

The bearing cage according to the present disclosure may have one or more of the following features.

According to one embodiment, a plurality of pocket sections are defined on the second side ring, each pocket section being located along the circumferential direction between two adjacent bridges, and each pocket section is provided with one or more oil storage holes open toward the first side ring. The oil storage holes of the bearing cage according to this embodiment can store a certain amount of lubricating oil therein so that they can provide lubrication for the rollers when the amount of lubricating oil splashed to the rollers is insufficient. This can serve as auxiliary lubrication in a case of low rotational speed of the bearing, such as when the equipment is just turned on. Under an extreme working condition in which no oil splashes onto the rollers, the lubricating oil stored in the oil storage holes can also provide lubrication for the rollers, thus improving the burning resistance of the bearing, which is especially beneficial to the equipment.

Accord to one embodiment, the outer diameter of the first side ring is smaller than that of the second side ring, and respective radially outer sides of the first side ring and the plurality of bridges roughly conform to the shape of a conical surface. The bearing cage according to this embodiment is used for tapered roller bearings, and it can improve lubrication under low-speed rotation, high-speed rotation and extreme working conditions of the bearings.

According to one embodiment, the first side ring is sized such that the outer diameter of the first side ring is slightly smaller than the inner diameter of an end of the bearing outer ring closer to the first side ring in the installed state, and the inner diameter of the first side ring is slightly larger than the outer diameter of an end of the bearing inner ring closer to the first side ring in the installed state. Such a size of the first side ring is defined to avoid the interference of components caused by radial movement of the cage, and it is obtained through corresponding size calculation and verification. The bearing cage according to this embodiment allows the lubricating oil moving toward a side of the bearing to reach the rollers basically only by passing through between the circumferential projections rather than other gaps between the bearing cage and the inner ring, thus maximizing the difference of the amount of lubricating oil reaching the rollers between the low-speed rotation and the high-speed rotation of the bearing.

According to one embodiment, each pocket section is provided with a plurality of oil storage holes, the plurality of oil storage holes being distributed along the circumferential direction on respective pocket section. The distribution of the oil storage holes of the bearing cage according to this embodiment can more effectively retain the lubricating oil around the rollers so that more lubricating oil can be stored for, for example, low-speed rotation and extreme working conditions.

According to one embodiment, each oil storage hole is formed as a cylindrical space extending in the depth direction of the oil storage hole, that is generally axially, or, in the case of a bearing cage for a tapered roller bearing, generally toward the second ring of the cage. The bearing cage according to this embodiment is convenient to manufacture and stable in structure.

According to one embodiment, preferably, gaps are respective defined on the first side ring between adjacent circumferential projections, the plurality of gaps are distributed circumferentially and at equal intervals at the radially inner side of the first side ring, and each of the plurality of gaps extends circumferentially along the radially inner side of the first side ring with the same radial depth. The bearing cage according to this embodiment is convenient to manufacture and runs more stably during the rotation of the bearing.

According to one embodiment, the first side ring is circular, each of the plurality of circumferential projections extends along a first arc of the circular first side ring and each of the plurality of gaps extends along a second arc of the circular first ring. Also an angular extent of the first arc is substantially equal to an angular extent of the second arc. Each of the gaps may have a same radial depth, and each of the circumferential projections may have a same radial thickness.

According to one embodiment, preferably, the number of the plurality of gaps is four. This embodiment is a preferred solution of the aforementioned embodiments. The bearing cage according to this embodiment is more convenient to manufacture and stable in structure.

According to one embodiment, preferably, the bearing cage is made of polymer. The bearing cage according to this embodiment is easy to manufacture and light in weight, which contributes to the lightweight of parts and equipment.

According to a second aspect of the present disclosure, a bearing is provided, the bearing including any one of the bearing cages described above.

In order to illustrate the technical solutions of the embodiments of the present disclosure more clearly, the accompanying drawings of the embodiments of the present disclosure will be briefly introduced hereinafter. The accompanying drawings are only used to illustrate some embodiments of the present disclosure, but not to limit all the embodiments of the present disclosure thereto.

### BRIEF DESCRIPTION OF THE DRAWINGS

FIG. 1 is a perspective view of a bearing cage according to an embodiment of the present disclosure.

FIG. 2 is a side elevational view of the bearing cage of FIG. 1.

FIG. 3 is a side elevational axial view showing a shape of the gaps of the bearing cage of FIG. 1.

FIG. 4 is a cross-sectional view of the bearing cage according to FIG. 1 installed in a bearing, at a location where a roller that would be located at the location of the cross-section is not shown.

FIG. 5 is a cross-sectional view of the bearing cage according to FIG. 1 installed in a bearing where a roller located at the location of the cross-section is shown.

FIG. 6 is another cross-sectional view of the bearing cage according to an embodiment of the present disclosure when installed in a bearing, and the roller at the cross-section is not shown.

FIG. 7 is another cross-sectional view of the bearing cage according to an embodiment of the present disclosure when installed in a bearing, and the roller at the cross-section is shown.

FIG. 8 is an elevational view of part of a pocket of the bearing cage of FIG. 1.

### DETAILED DESCRIPTION

In order to make the purpose, technical solution and advantages of the technical solutions of the present disclosure clearer, the technical solutions of the embodiments of the present disclosure will be clearly and completely described below with reference to the drawings of specific embodiments of the present disclosure. In the drawings, the same reference numerals represent the same parts. It should be noted that the described embodiments are part of the embodiments of the present disclosure, but not all of them. Based on the described embodiments of the present disclosure, all other embodiments obtained by those of skills in the art without creative labor are within the protection scope of the present disclosure.

Unless otherwise defined, the technical terms or scientific terms used here shall have their ordinary meanings as understood by those with ordinary skills in the field to which this invention belongs. The words “first”, “second” and the like used in the description and claims of the patent application of the present disclosure do not indicate any order, quantity or importance, but are only used to distinguish different components. Similarly, words “a” or “an” and the like do not necessarily mean quantity limitation. Words “comprising” or “including” and the like mean that the elements or objects appearing before the word cover the listed elements or objects appearing after the word and their equivalents, without excluding other elements or objects. Phrases like “connected to” or “connected with” are not limited to physical or mechanical connections, but can include electrical connections, whether direct or indirect. “Up”, “down”, “left” and “right” are only used to express relative positional relationship. When the absolute position of the described object changes, the relative positional relationship may also change accordingly.

The present disclosure will be described in detail below by describing example embodiments.

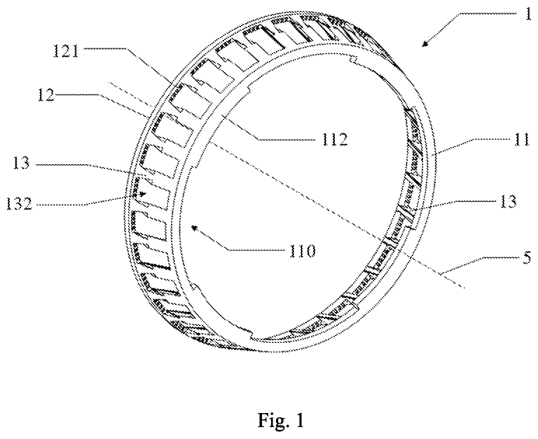

FIG. 1 shows a bearing cage 1 according to an embodiment of the present disclosure. As shown in FIG. 1, the bearing cage 1 includes a first side ring 11 and a second side ring 12. The first side ring 11 and the second side ring 12 are connected by a plurality of bridges 13. Adjacent bridges 13 among the plurality of bridges 13 together with the first side ring 11 and the second side ring 12 form a plurality of pockets 132 for receiving rollers 4, 4′ respectively. According to an embodiment of the present disclosure, the plurality of bridges 13 are preferably arranged at equal intervals.

The first side ring 11 and the second side ring 12 of the bearing cage 1 are coaxial and have a common central axis 5. That is, a line connecting the respective centers of the first side ring 11 and the second side ring 12 defines the central axis 5. When the bearing is running, the bearing cage 1 rotates around the central axis 5. An axial direction, a radial direction and a circumferential direction are defined relative to the central axis 5.

In the embodiment of FIG. 1, the diameter of the first side ring 11 is smaller than the diameter of the second side ring 12, and the first side ring 11, the second side ring 12 and the plurality of bridges 13 together form a generally frustum shape. That is, the radially outer sides of these parts roughly conform to the shape of a conical surface. Therefore, this bearing cage 1 is suitable for tapered roller bearings. However, without departing from the scope of the present disclosure, the diameter of the first side ring 11 may be roughly equal to diameter of the second side ring 12, and the first side ring 11, the second side ring 12 and the plurality of bridges 13 together may form a generally cylindrical shape. Thus, a bearing cage 1 with features described below also apply to cylindrical roller bearings or ball bearings.

As shown in FIG. 1, the radially inner side of the first side ring 11 has four circumferential projections 112 extending radially inward, and the radially inner surfaces of these four circumferential projections 112 are closer to the central axis 5 than the radially inner surfaces of the respective bridges 13.

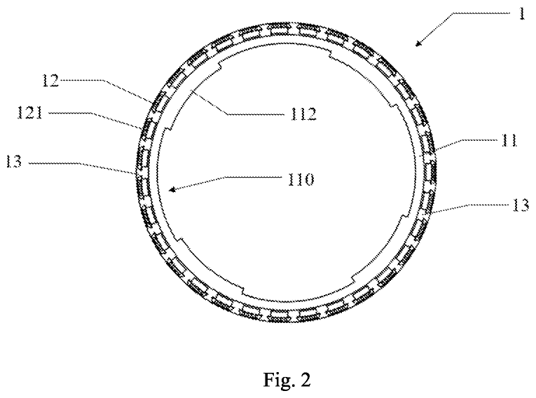

FIG. 2 further shows a view of the bearing cage 1 axially viewed from one side of the first side ring 11. In FIG. 2, the four circumferential projections 112 formed at the radially inner side the first side ring 11 and extending toward the central axis 5 can be seen more clearly. Gaps 110 are formed between adjacent circumferential projections 112. That is, a total of four gaps 110 are formed. The bottoms of each of the gaps 110 are recessed radially outward, i.e., toward the material of the first side ring 11, with respect to the radially innermost edges of the circumferential projections 112 on the two circumferential sides of the gap. Each gap 110 penetrates the first side ring 11 in the axial direction, thereby allowing lubricating oil to pass through the first side ring 11 and reach the rollers 4, 4′ located between the first side ring 11 and the second side ring 12. In the bearing cage 1 shown in FIGS. 1 and 2, the gaps 110 are distributed circumferentially at equal intervals.

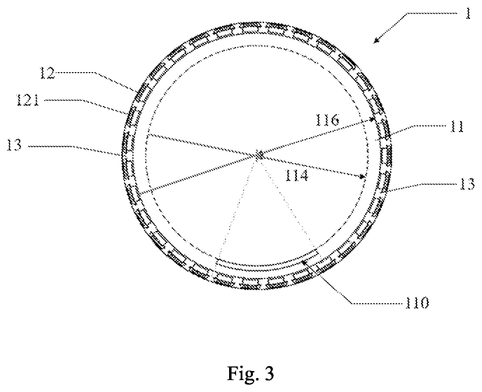

FIG. 3 further shows the geometry of the first side ring 11 of the bearing cage 1, in which the outer diameter 116 of the first side ring 11 and the inner diameter 114 of the first side ring 11 are shown (as dotted lines). In this embodiment, the inner diameter 114 of the first side ring 11 is the radius of the radially inner surfaces of the four circumferential projections 112. FIG. 3 also schematically shows a gap 110, which is recessed radially outward, with a constant recessing depth along the circumferential direction, and the gap 110 penetrates the first side ring 11 in the axial direction. Such a shape of the gap 110 not only enables the above-mentioned effect of controlling the amount of lubricating oil reaching the rollers 4, 4′ at different rotational speeds of the bearing, but also simplifies the manufacturing process and makes the obtained first side ring 11 stable in structure.

Actually, according to the foregoing description, as long as the gaps 110 formed on the first side ring 11 extend along the axial direction throughout the axial thickness of the first side ring 11, the shapes of the gaps 110 may be different, and it is possible that the radially recessing depth of each gap 110 along the circumferential direction is not a constant value, but a variable value. Moreover, the number of gaps 110 on the first side ring 11 may be another suitable number than four, for example, five, six or more. In addition, it is possible that the gaps 110 are not distributed at equal intervals along the circumferential direction. For example, there may be an even number of gaps 110 on the first side ring 11, and the gaps 110 are only symmetrical in pairs about the central axis 5.

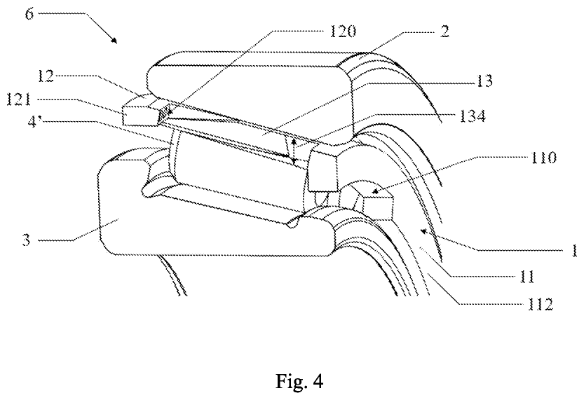

Returning to FIG. 1, the radially outer surface of the first side ring 11 is flush with the radially outer surfaces of the bridges 13, and together they form a shape that roughly conforms to a conical surface. Therefore, this feature, together with the features of the gaps 110, can achieve the effect of controlling the amount of lubricating oil reaching the rollers 4, 4′ at different rotational speeds of the tapered roller bearing. FIGS. 4 to 7 show cross-sectional views of the bearing cage 1 installed in a bearing 6. The bearing 6 includes a bearing cage 1 according to an embodiment of the present disclosure, an outer bearing ring 2, an inner bearing ring 3 and a plurality of rollers 4, 4′ confined between the bearing cage 1, the outer bearing ring 2 and the inner bearing ring 3, which are assembled together.

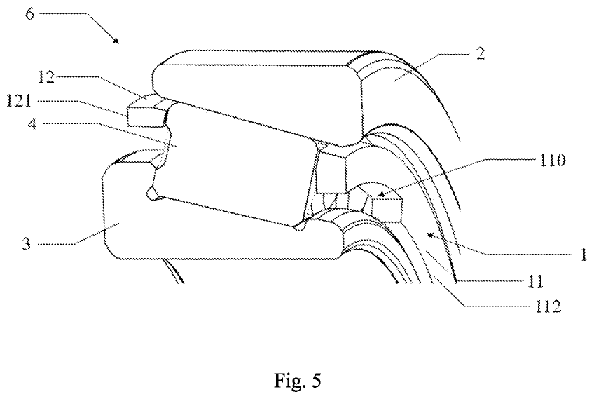

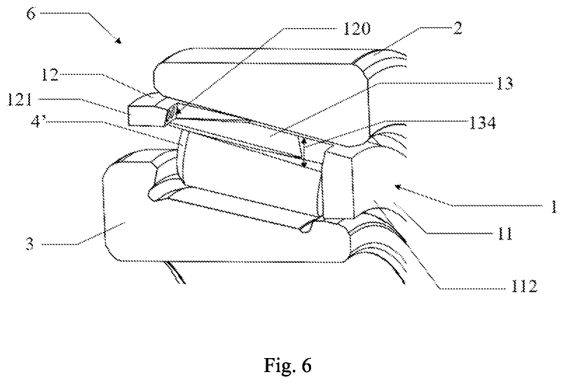

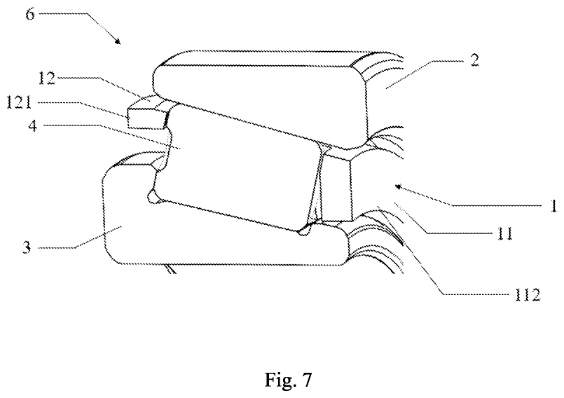

Among FIGS. 4 to 7, the cross sections shown in FIGS. 4 and 5 pass through a gap 110, and the cross sections shown in FIGS. 6 and 7 do not pass through a gap 110, that is, the cross sections shown in FIGS. 6 and 7 pass through a circumferential projection 112 between adjacent gaps 110. FIGS. 4 and 6 do not show the roller 4 at the location of the cross section, while FIGS. 5 and 7 show the roller 4 at the location of the cross section. Referring to the position of the gap 110 shown in FIGS. 4 to 7 relative to the various components, especially the roller 4 in the installed state, it can be understood that for the lubricating oil that finally reaches the roller 4 from a side of the first side ring 11, most of the lubricating oil reaches the roller 4 through the axially penetrating gaps 110, and only a small portion may reach the roller 4 through gaps between the bearing cage 1, the outer ring 3 and the inner ring 2 (see FIGS. 4 and 5). If a circumferential projection, instead of a gap 110, is in front of the lubricating oil as it moves to the vicinity of the first side ring 11 (see FIGS. 6 and 7), then this portion of the lubricating oil may only reach the roller 4 through the gaps between the bearing cage 1 and the outer ring 2 and the inner ring 3, and it is more likely to be “cut off” by the circumferential projection 112.

Therefore, the bearing cage 1 according to the present disclosure can achieve the effect of controlling the amount of lubricating oil reaching the rollers 4, 4′ when the bearing 6 is at different rotational speeds by making the gaps 110 as the main passage through which lubricating oil can pass between the outer ring 2 and the inner ring 3. Therefore, according to another preferred embodiment, the first side ring 11 is sized such that the outer diameter 116 of the first side ring 11 is slightly smaller than the inner diameter of an end the outer bearing ring 2 closer to the first side ring 11 in the installed state, and the inner diameter 114 of the first side ring 11 is slightly larger than the outer diameter of an end of the inner ring 3 closer to the first side ring 11 in the installed state. In this case, the gaps 110 are basically the only passage between the outer ring 2 and the inner ring 3 through which the lubricating oil can pass, further enhancing the effect of controlling the amount of lubricating oil reaching the rollers 4, 4′ when the bearing 6 is at different rotational speeds.

Further referring to FIGS. 4 and 6, which show a plurality of oil storage holes 120 located on the second side ring 12 and open toward the first side ring 11. Specifically, the second side ring 12 defines a pocket section 121 located between two adjacent bridges 13 in the circumferential direction. The pocket section 121 is a section of the second side ring 12 along the circumferential direction and faces the pocket 132 accommodating a roller 4, 4′. Each pocket section 121 is provided with one or more oil storage holes 120 open toward the first side ring 11. The oil storage holes 120 can store the lubricating oil flowing through the rollers 4, 4′ from the vicinity of the first side ring 11 in time. Therefore, when the bearing 6 is short of lubricating oil, such as in a low-speed stage when the equipment starts to run or the extreme situation when no lubricating oil enters the bearing 6 due to equipment failure, the oil storage holes 120 provide lubricating oil for the rollers 4, 4′, which also improves the burning resistance of the bearing 6.

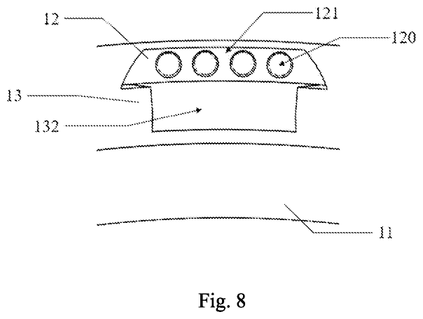

FIG. 8 shows a partial view of the bearing cage 1 viewed from the axial direction, which specifically shows a pocket section 121 and a plurality of oil storage holes 120 provided therein. As shown in FIG. 8, each pocket section 121 has four oil storage holes 120, and the oil storage holes 120 are distributed along the circumferential direction. Such a distribution makes it possible to capture a larger proportion of the lubricating oil flowing through the rollers 4, 4′. However, the number of the oil storage holes 120 as four in each pocket section 121 in this embodiment is only an example. In fact, each pocket section 121 may have more or less oil storage holes 120, and the number of which may be set according to the actual situation. In addition, the oil storage holes 120 shown in FIG. 8 are cylindrical and extend in the depth direction of the oil storage hole 120 (generally perpendicularly to the surface in which the storage holes are formed. Such a shape of the oil storage holes 120 is convenient to manufacture and makes the bearing cage 1 stable in structure. However, according to other embodiments, the oil storage holes 120 may also have other spatial shapes and other distributions or arrangements on the pocket section 121. In addition, the bearing cage 1 of the present disclosure may be made of polymer, which makes the manufacturing process of the bearing cage 1 in the above embodiments easier, thereby reducing the manufacturing cost and reducing the weight of the bearing cage 1 and of the bearing 6 as a whole.

Exemplary embodiments of the bearing cage and the bearing proposed by the present disclosure have been described in detail above with reference to the preferred embodiments. However, it can be understood by those skilled in the art that various variations and modifications can be made to the above specific embodiments without departing from the concept of the present disclosure, and various technical features and structures proposed by the present disclosure can be combined in various ways without exceeding the protection scope of the present disclosure.

### REFERENCE NUMERAL LIST

1 bearing cage
11 first side ring
110 gap
112 circumferential projection
114 inner diameter of first side ring
116 outer diameter of first side ring
12 second side ring
120 oil storage hole
121 pocket section
13 bridge
132 pocket
134 thickness of bridge
2 outer ring
3 inner ring
4, 4′ roller
5 central axis
6 bearing

What is claimed is:

1. A bearing cage for holding rollers between an outer ring and an inner ring of a bearing, comprising:
a first side ring;
a second side ring axially spaced from the first side ring; and
a plurality of circumferentially spaced bridges connecting the first side ring and the second side ring,
wherein the first side ring includes at least one radially inward extending circumferential projection.

2. The bearing cage according to claim 1,
wherein the at least one circumferential projection comprises a plurality of circumferential projections distributed at equal intervals around the first side ring.

3. The bearing cage according to claim 1,
wherein the at least one circumferential projection comprises a plurality of circumferential projections separated from each other by a plurality of gaps.

4. The bearing cage according to claim 3,
wherein each of the plurality of gaps has a same radial depth.

5. The bearing cage according to claim 1,
wherein the first side ring includes at least one oil storage hole at a location between each adjacent pair of the plurality of bridges.

6. The bearing cage according to claim 5,
wherein the oil storage hole is cylindrical.

7. The bearing cage according to claim 6,
wherein the oil storage hole extends in a direction parallel to a central axis of rotation of the bearing ring.

8. The bearing cage according to claim 5,
wherein the at least one oil storage hole comprises a plurality of the oil storage holes spaced in a circumferential direction.

9. The bearing cage according to claim 1,
wherein an outer diameter of the first side ring is smaller than an outer diameter of the second side ring, and
wherein a radially outer side of the first side ring and a radial outer sides of the plurality of bridges lie on an imaginary cone.

10. The bearing cage according to claim 1,
wherein the bearing cage is made of polymer.

11. The bearing cage according to claim 2,
wherein the first side ring is circular,
wherein each of the plurality of circumferential projections extends along a first arc of the circular first side ring,
wherein each of the plurality of gaps extends along a second arc of the circular first ring, and
wherein an angular extent of the first arc is substantially equal to an angular extent of the second arc.

12. The bearing cage according to claim 3,
wherein each of the gaps has a same radial depth, and
wherein each of the circumferential projections has a same radial thickness.

13. The bearing cage according to claim 1,
wherein a radially inner edge of each of the plurality of projections lies on an arc of a same imaginary circle.

14. A bearing comprising:
an outer ring;
an inner ring;
rollers arranged between the outer ring and the inner ring; and
a bearing cage according to claim 1,
wherein the rollers are retained between the outer ring and the inner ring by the bearing cage.
